(19) United States
(12) Patent Application Publication
(10) Pub. No.: US 2008/0295141 A1
(43) Pub. Date: Nov. 27, 2008

(54) PERSONALIZED TV APPARATUS

(75) Inventor: Xu Dong, Grand Cayman (KY)

Correspondence Address: FAY SHARPE LLP, 1100 SUPERIOR AVENUE, SEVENTH FLOOR, CLEVELAND, OH, 44114, US

(73) Assignee: PowerLayer Microsystems Holding Inc., Grand Cayman (GB)

(21) Appl. No.: 11/832,120

(22) Filed: Aug. 1, 2007

(30) Foreign Application Priority Data
May 22, 2007 (CN) CN200710107605.0

(51) Int. Cl. H04N 7/173

(52) U.S. Cl. 725/110

(57) ABSTRACT

A personalized TV apparatus and a method of using it to access entertainment information from the Internet are disclosed. The TV apparatus includes a CPU, storage device, network interface, switch, decoder and search, download, and management modules running on the CPU. The CPU in the TV apparatus can automatically search the Internet in the background in real time and download the located content into the storage device. The viewer can then view the content from the storage device. The TV apparatus also has a self training module to make the downloaded content match the viewer's choice slowly to increase the viewer's satisfaction.

### BACKGROUND

This application claims priority to Chinese patent application CN200710107605.0, filed May 22, 2007. That application is hereby fully incorporated by reference.

The present disclosure relates to a personalized TV apparatus suitable for watching both broadcast television and Internet content. Devices and methods for using those devices are also disclosed.

TV is one of the best entertainment devices invented in 20th century. However, in the Internet-connected 21st century, it is not good enough. Existing TV apparatuses can only receive programs transmitted by broadcasters. Millions of programs available from different sources, such as the Internet, are not reachable by TV viewers through today's TV apparatuses.

The Internet has expanded rapidly in the last 10 years. Much of the younger generation browses the Internet on their personal computer (PC) everyday. As the result of telecommunication industry growth in the last decade, with reasonable transmission speed, bandwidth and cost to the home, many on-line video content providers, such as YouTube and Tudou.com, provide 100 times more information than today's broadcasters can.

A personal computer is an interactive tool for a single person to operate. In browsing the Internet, the user must go through a searching process to get to the final result. However, a TV is a family entertainment center; usually two or more family members watch programs together. People watch TV in a relaxed mode and usually expect definite program content instead of needing to search for unknown materials.

Many inventors have tried very hard to combine the PC and the TV together by building TV on a PC or by building a PC as a TV, etc. So far, all attempts have failed because a PC was too expensive and too hard to operate, the Internet connection was too slow, or Internet browsing was too time consuming and not suitable for family entertainment.

### BRIEF DESCRIPTION

Disclosed, in various embodiments, are devices for watching both broadcast TV and Internet content. Also disclosed are methods for using such devices.

In embodiments, a personalized TV apparatus comprises: a TV signal input port; a demodulator; a signal processor; a TV signal output port; a CPU; a storage device; a network port; a switch; a decoder; a search module; a download module; and a management module.

Content may be stored on the storage device in a format selected from the group consisting of MPEG1, MPEG2, MPEG4, H.264, AVS, Divx, Xvid, VC1, Real, and AVI.

The storage device may be a semiconductor device, an electromagnetic device, or an optical device.

The search module may further comprise a self-training module.

The CPU, network port, and decoder may be located on a single silicon device; wherein the search module comprises memory which stores a search routine and the CPU for executing the search routine; wherein the download module comprises memory which stores a download routine and the CPU for executing the download routine; and wherein the management module comprises memory which stores a management routine and the CPU for executing the management routine.

The TV apparatus may further comprise a display device operatively connected to the TV signal output port. The TV signal output port itself may comprise a display device to display a TV output signal.

In other embodiments, a method of accessing Internet content comprises:
providing a personalized TV apparatus, comprising: a TV signal input port; a demodulator; a signal processor; a TV signal output port; a CPU; a storage device; a network port; a switch; a decoder; a search module; a download module; and a management module;
automatically searching the Internet for content using the search module;
downloading the content to the storage device using the download module;
receiving a request to select a personalized TV program channel from a remote control device;
displaying an electronic program guide to the content stored on the storage device;
selecting a content choice from the guide; and
sending through the TV signal output port the content stored on the storage device corresponding to the content choice.

The method may further comprise the step of determining a user's favorites based on previous selections of content choice made by the user.

The method may further comprise the step of deleting content stored on the storage device which is not selected by a user after a period of time.

The downloading step may further comprise downloading only content corresponding to a user's favorite selections.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a diagram of a personalized TV apparatus of the instant disclosure.

FIG. 2 is a flowchart of a method of the instant disclosure for using a personalized TV apparatus.

### DETAILED DESCRIPTION

A more complete understanding of the devices, processes, and components disclosed herein can be obtained by reference to the accompanying drawings. These drawings are merely schematic representations based on convenience and the ease of demonstrating the present disclosure, and are, therefore, not intended to indicate relative size and dimensions of the devices or components thereof and/or to define or limit the scope of the present disclosure.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

To add value to millions of TV viewers, a personalized TV apparatus and a method of using the personalized TV apparatus to access the Internet provides more channels and personal choices to each TV viewer, who may build their own channels to view content available on the internet.

A personalized TV apparatus comprises a TV signal input port, demodulator, signal processor, TV signal output port for normal TV signals, a CPU, a storage device, a network port, a switch, a decoder, and search, download, and management modules running on the CPU.

The CPU has an operating system, a search module for searching the Internet, a download module for downloading program content from the Internet, and a management module for managing the graphics user interface (GUI) of the personalized TV apparatus. The CPU also controls the TV signal input port, demodulator, signal processor, and TV signal output port.

The network port connects to the Internet. The CPU searches for content on the Internet through the network port and downloads located content from the Internet to the storage device.

The storage device stores the content downloaded from the Internet through the network port.

The decoder reads and decodes viewer-selected content from the storage device and sends the decoded content to the switch.

Controlled by the CPU, the switch selects normal broadcast TV content or the decoded content from the decoder and sends the selected signal to the TV signal output port.

The TV output port outputs or displays the selected content from the switch.

The management module manages the GUI and content in the storage device. It updates the content on the storage device in real time.

The content on the storage device may be stored in a file format selected from, but not limited to, MPEG1, MPEG2, MPEG4, H.264, AVS, Divx, Xvid, VC1, Real and AVI.

The storage device is a semiconductor device, an electromagnetic device or an optical device.

The search module has a self training module that optimizes the search accuracy according to the viewer's selections.

The CPU, network port, and decoder are integrated in a single silicon device. The search, download, and management modules run on the CPU integrated in the silicon device.

The personalized TV apparatus may also include a display device to connect to the TV signal output port to display the output signal. Alternately, the TV signal output port itself is a display device to display the output signal from the switch.

A method of accessing Internet content may comprise:

Step A: The CPU in a TV apparatus automatically searches the Internet in the background in real time and downloads the located content to the storage device. The TV apparatus displays a program content introduction, such as an electronic program guide to the content stored in the storage device, when it receives a request to select a personalized TV program channel from the viewer through a remote control device.

Step B: The viewer selects desired content from the program content introduction.

Step C: The TV apparatus displays the content selected by the viewer.

The search module in the TV apparatus runs in the background and determines the viewer's favorites according to viewer's selections. It deletes content that has not been selected by the viewer for a certain time. It can search and downloads only content which it believes the viewer will be interested in from the Internet.

One benefit of such a device is that it adds more channels to the TV apparatus (compared to only broadcast TV) by downloading program content from the Internet to the storage device in the TV apparatus. At the same time, the self training module of the TV apparatus can set up a series of personalized TV channels to satisfy a TV viewer by selecting program content according to the viewer's personal interests.

The general method of accessing Internet content is browsing online through a personal computer. However, a personal computer is an interactive tool for a single person to operate. In browsing the Internet, the user must go through a searching process to get to the final result. However, a TV is a family entertainment center; usually two or more family members watch programs together. People watch TV in a relaxed mode and usually expect definite program content instead of needing to search for unknown materials. In general, TV viewers do not spend time and effort to actively search online when they are watching TV programs. In this disclosure, online searching and downloading is running automatically in the background and the GUI is set as a standard TV channel. Therefore, all the viewer needs to do is just enjoy watching a TV program.

Most viewers are annoyed by the frequent-pause effect when watching a streaming video program, which is caused by the narrow network bandwidth and the slow network transmission speed. In this disclosure, online searching and downloading is running in the background. The located content is downloaded onto the storage device even the TV apparatus is in stand-by mode. When the viewer is watching the personalized TV channel, the signal content is actually playing back from the storage device in real time, without any frequent-pause effect, unless the viewer wants to pause the playback.

The TV apparatus not only can display normal broadcasting programs or digital TV programs, but can also play back personalized TV programs which are downloaded from the Internet.

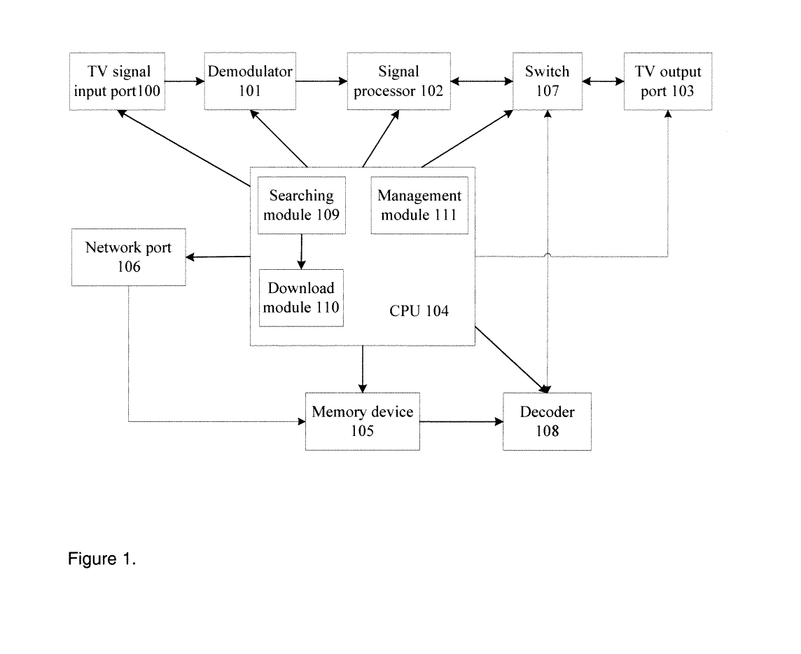

As shown in FIG. 1, one embodiment provides a personalized TV apparatus which comprises all components and blocks of a normal TV apparatus, such as TV signal input port 100, demodulator 101, signal processor 102 and TV signal output port 103. The TV apparatus also has the following blocks: CPU 104, memory device 105, network port 106, switch 107, and decoder 108.

The TV signal input port 100 receives broadcast TV signals and digital TV signals. It can be a TV antenna, cable TV input port, DTV interface or IP interface.

The demodulator 101 separates audio, video and control signals from the signal received by the TV signal input port.

The signal processor 102 processes the signal from demodulator 101. The signals are usually NTSC, PAL or HDTV signals. The processed signal is sent to the TV output port 103 through the switch 107.

The TV output port 103 outputs the signal from either the signal processor 102 or the decoder 108.

An operating system such as Linux or Windows runs on the CPU 104. The search module 109 which searches the Internet, download module 110, and management module 111 run on the CPU 104 as well. The CPU receives the selection signal from the viewer; and controls the TV signal input port 100, demodulator 101, signal processor 102, storage device 105, network port 106, switch 107, and decoder 108.

The storage device 105 stores the program content downloaded from the internet through the network port 106. It is a mass capacity storage device, such as a hard-disk over 100 GB. The network port 106 connects to the Internet.

The switch 107 selects the signal to be displayed by the TV output port 103 under the control of the CPU 104.

The decoder 108 plays back the content selected by the viewer from the storage device, decodes it into a base band video signal, and displays it on the TV output port 103 through the switch 107.

The search module 109 searches the internet in real time through the network port 106. The download module 110 downloads located content into the storage device 105.

The management module 111 manages the GUI and the content in the storage device 105. It also updates the downloaded content in real time when the GUI is set as a TV channel with an electronic program guide to show the program content for a viewer to select from.

The storage device is a semiconductor device such as a flash memory, an electromagnetic device such as a hard-disk, or an optical device such as a writable DVD disk.

The management module 111 has a built-in self training module. It can optimize the searched-for content based on the viewer's selections in a certain past time period, i.e. it only searches for those types of content that the viewer watches frequently.

To lower the cost of the TV apparatus, the CPU 104, network port 106 and decoder 108 can be integrated into one silicon device. The search module 109, download module 110, and management module 111 will run on the CPU 104 in the integrated silicon device.

The TV apparatus may further comprise a display device to connect to the TV signal output port 103 to display the output signal from the TV signal output port 103. The TV signal output port 103 may itself be a display device as a CRT, LCD or PDP device to display the signal coming from the switch 107.

When the viewer use this personalized TV apparatus, he or she selects the content through a remote control unit. If a normal TV channel is selected, the remote control sends an instruction to the CPU 104. The CPU 104 receives the instruction, controls the demodulator 101 to pick up the TV signal from the TV signal input port 100, controls the signal processor 102 to process the TV signal, and sends the processed signal to display on the TV signal output port 103 through the switch 107. If the viewer selects an add-on personalized channel, the CPU 104 controls the signal played back from the storage device 105, decodes it by the decoder 108, and displays it on the TV signal output port 103 through the switch 107.

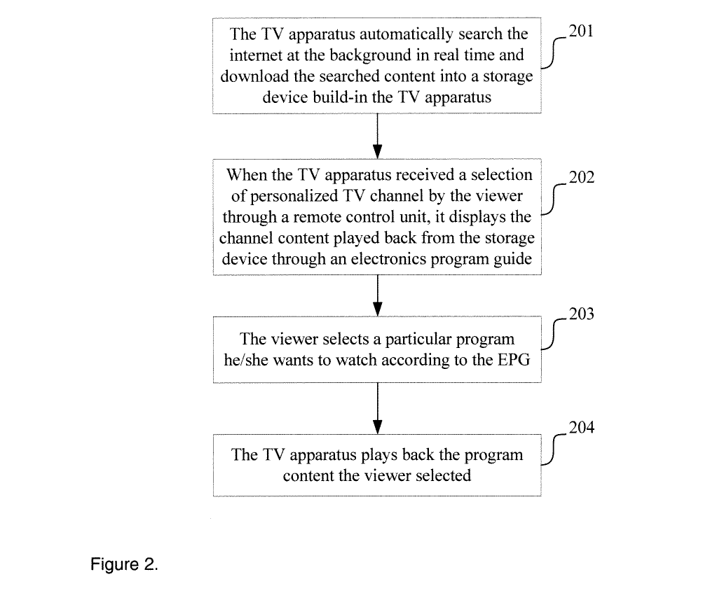

As shown in FIG. 2, the implementation provides a method to access Internet content by using the personalized TV apparatus. The method comprises:

Step 201: The TV apparatus automatically searches the Internet in the background in real time and downloads the located content into a storage device built in the TV apparatus.

The downloaded content can be sport programs, movies (classic, action, love story, etc.), TV dramas (Soap Opera, Classic, modern, etc.), a blog, news, and so on. The search and download processes are operated by the TV automatically in the background; it does not require the viewer to do anything. To simplify the viewer's watching experience, the downloaded content can be categorized into different channels, such as sport channel, movie channel, TV drama channel, blog channel, news channel, and so on.

Step 202: When the TV apparatus receives a request to view a personalized TV channel by the viewer through a remote control unit, it displays the channel content which can be played back from the storage device through an electronics program guide (EPG).

The viewer, based on his/her personal interests, selects the channel s/he wants to watch by the remote control, e.g. to turn to the TV drama channel. After receiving this instruction, the TV apparatus displays all relevant program information on the storage device for the viewer to select. The information can include the program name, names of actors and actresses, a brief introduction of the story, etc.

Step 203: The viewer selects a particular program s/he wants to watch according to the EPG.

Step 204: The TV apparatus plays back the program content selected by the viewer.

After a certain time period, such as one month or one week, the TV apparatus can determine the viewer's interests according to the programs selected, e.g. liking TV drama and not liking sports programs. The TV apparatus will delete those programs that the viewer does not like and search and download additional program content that the viewer likes.

The TV apparatus can also provide on-demand service when the viewer has a specific request for certain program content, e.g., when a viewer wants to watch a particular TV drama, s/he can enter the TV drama's name via a keyboard. The TV apparatus will search for the TV drama on the internet. The TV apparatus can also ask the viewer how to pay for the service and then decide how to continue processing according to the viewer's answer.

Today, several varieties of internet broadband connections to the home are available, e.g. DSL, WiFi, Wireless, 3G, etc. Advanced digital processing technology can embed a powerful 32-bit or 64-bit CPU and multi-format compression decoder into an integrated circuit with reasonable cost and advanced operating systems such as Linux and Microsoft Windows can run on the CPU. The personal video recorder (PVR) function provides huge storage capacity and time shifting concept to the TV apparatus. Therefore, all technologies discussed in this disclosure can be found today. The purpose of this disclosure is to provide more channels and personal choices to the TV viewers and, at the same time, keep the cost of the TV apparatus low as well.

The devices and methods of the present disclosure have been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A personalized TV apparatus, comprising: a TV signal input port; a demodulator; a signal processor; a TV signal output port; a CPU; a storage device; a network port; a switch; a decoder; a search module; a download module; and a management module.

2. The TV apparatus of claim 1, wherein content is stored on the storage device in a format selected from the group consisting of MPEG1, MPEG2, MPEG4, H.264, AVS, Divx, Xvid, VC1, Real, and AVI.

3. The TV apparatus of claim 1, wherein the storage device is a semiconductor device, an electromagnetic device, or an optical device.

4. The TV apparatus of claim 1, wherein the search module further comprises a self-training module.

5. The TV apparatus of claim 1, wherein the CPU, network port, and decoder are located on a single silicon device; wherein the search module comprises memory which stores a search routine and the CPU for executing the search routine; wherein the download module comprises memory which stores a download routine and the CPU for executing the download routine; and wherein the management module comprises memory which stores a management routine and the CPU for executing the management routine.

6. The TV apparatus of claim 1, further comprising a display device operatively connected to the TV signal output port.

7. The TV apparatus of claim 1, wherein the TV signal output port comprises a display device to display a TV output signal.

8. A method of accessing Internet content, comprising:
providing a personalized TV apparatus, comprising: a TV signal input port; a demodulator; a signal processor; a TV signal output port; a CPU; a storage device; a network port; a switch; a decoder; a search module; a download module; and a management module;
automatically searching the Internet for content using the search module;
downloading the content to the storage device using the download module;
receiving a request to select a personalized TV program channel from a remote control device;
displaying an electronic program guide to the content stored on the storage device;
selecting a content choice from the guide; and
sending through the TV signal output port the content stored on the storage device corresponding to the content choice.

9. The method of claim 8, further comprising the step of determining a user's favorites based on previous selections of content choice made by the user.

10. The method of claim 8, further comprising the step of deleting content stored on the storage device which is not selected by a user after a period of time.

11. The method of claim 8, wherein the downloading step further comprises downloading only content corresponding to a user's favorite selections.
